(19) United States
(12) Patent Application Publication
(10) Pub. No.: US 2005/0272828 A1
(43) Pub. Date: Dec. 8, 2005

(54) Fine cell flexible polyurethane foam

(75) Inventor: Koji Fujiwara, Yokohama (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION

(21) Appl. No.: 11/181,802

(22) Filed: Jul. 15, 2005

(30) Foreign Application Priority Data
Jan. 17, 2003 (JP) 2003-009148
Jul. 8, 2003 (JP) 2003-193716

(51) Int. Cl. C08G 18/00

(52) U.S. Cl. 521/155

(57) ABSTRACT

A flexible polyurethane foam having a significantly fine cell structure is produced by blowing and curing a mixture of an isocyanate-terminated prepolymer, a cross-linking agent, and a blowing component. The isocyanate-terminated prepolymer is prepared by reacting a polyol component with a polyisocyanate. The polyol component includes at least one low-molecular-weight polyol having a number average molecular weight of 400 to 1,000 and at least one high-molecular-weight polyol having a number average molecular weight of 3,000 to 12,000. The physical association of cells can be inhibited with the aid of the difference in reactivity between the isocyanate-terminated prepolymers derived from the low-molecular-weight polyol and the high-molecular-weight polyol to provide a flexible polyurethane foam having a fine cell structure.

### CROSS REFERENCE TO RELATED APPLICATION

This is a continuation application of PCT/JP2004/000156 filed on Jan. 13, 2004.

### TECHNICAL FIELD

The present invention relates to fine cell flexible polyurethane foams. In particular, the present invention relates to a fine cell flexible polyurethane foam that has a significantly fine cell structure to deliver excellent performance as a foam material for, for example, sound absorbers, electrodes, and printer rollers. In addition, the present invention relates to a fine cell flexible polyurethane foam having a significantly fine cell structure with excellent flame retardancy. Such a polyurethane foam is useful in applications requiring flame retardancy, including toner seals, air seals, sound absorbers for OA equipment and vehicles, and electrodes.

### BACKGROUND ART

A method for producing a flexible polyurethane foam from an isocyanate-terminated prepolymer prepared by reacting a polyol with a polyisocyanate is conventionally known. According to this method, a polyol having a relatively high molecular weight is reacted with a polyisocyanate to prepare an isocyanate-terminated prepolymer which is blown and cured by adding and mixing a catalyst and a blowing agent to produce a flexible polyurethane foam.

The flexible polyurethane foam thus produced is used for, for example, sound absorbers, electrodes, and printer rollers. In such applications, it is important that the flexible polyurethane foam have a finer cell structure in terms of sound absorbency, as a material for sound absorbers, higher capacitance, as a material for electrodes, and mechanical strength and durability, as a material for rollers and other applications. In addition, flame retardancy is required in applications such as toner seals, air seals, sound absorbers for OA equipment and vehicles, and electrodes.

However, the minimum possible cell size of flexible polyurethane foams produced by the conventional method is limited to about 250 μm; flexible polyurethane foams having even finer cells are desired. In addition, conventionally, no fine cell flexible polyurethane foams available have flame retardancy, and thus there is no polyurethane foam that can be applied to applications requiring flame retardancy.

### DISCLOSURE OF INVENTION

In light of the above conventional circumstances, a first object of the present invention is to provide a flexible polyurethane foam having a significantly fine cell structure.

A second object of the present invention is to provide a flexible polyurethane foam having a significantly fine cell structure with excellent flame retardancy.

A fine cell flexible polyurethane foam according to a first aspect is produced by blowing and curing a mixture of an isocyanate-terminated prepolymer, a cross-linking agent, and a blowing component. The isocyanate-terminated prepolymer is prepared by reacting a polyol component with a polyisocyanate. The polyol component includes at least one low-molecular-weight polyol having a number average molecular weight of 400 to 1,000 and at least one high-molecular-weight polyol having a number average molecular weight of 3,000 to 12,000.

According to the first aspect, an isocyanate-terminated prepolymer prepared by reacting two or more polyols having different molecular weights with a polyisocyanate may be used to inhibit the physical association of cells with the aid of the difference in reactivity between the isocyanate-terminated prepolymers derived from the low-molecular-weight polyol and the high-molecular-weight polyol. The first aspect can therefore provide a flexible polyurethane foam having a fine cell structure.

A flame-retardant fine cell flexible polyurethane foam according to a second aspect is produced by blowing and curing a mixture of an isocyanate-terminated prepolymer, a flame retardant, a cross-linking agent, a foam stabilizer, and a blowing component. The isocyanate-terminated prepolymer is prepared by reacting a polyol component with a polyisocyanate at a weight ratio of 1:0.15 to 1:0.4. The polyol component includes at least one low-molecular-weight polyol having a number average molecular weight of 400 to 1,000 and a functionality of 3 or more and at least one high-molecular-weight polyol having a number average molecular weight of 3,000 to 12,000 and a functionality of 3 or more. The proportion of the low-molecular-weight polyol in the polyol component is 30% or more by weight. The cross-linking agent is a low-molecular-weight polyol having a functionality of 3 or more, and the amount of the cross-linking agent added is 3.0 to 10.0 parts by weight based on 100 parts by weight of the isocyanate-terminated prepolymer. The blowing component includes a blowing agent mainly containing water and a catalyst, and the amount of the blowing agent added is 0.5 to 2.0 parts by weight based on 100 parts by weight of the isocyanate-terminated prepolymer. The polyisocyanate is one or more materials selected from the group consisting of 2,4-tolylene diisocyanate, 2,6-tolylene diisocyanate, and diphenylmethane-4,4′-diisocyanate.

According to the second aspect, an isocyanate-terminated prepolymer prepared by reacting two or more polyols having different molecular weights with a polyisocyanate may be used to inhibit the physical association of cells with the aid of the difference in reactivity between the isocyanate-terminated prepolymers derived from the low-molecular-weight polyol and the high-molecular-weight polyol. The second aspect can therefore provide a flexible polyurethane foam having a fine cell structure. Moreover, a predetermined content of the low-molecular-weight polyol having a functionality of 3 or more provides higher cross-linking density so that even finer cells can be formed. Furthermore, the addition of the flame retardant provides excellent flame retardancy.

### BEST MODE FOR CARRYING OUT THE INVENTION

A fine cell flexible polyurethane foam according to a preferred embodiment of the first aspect will now be described in detail.

First, an isocyanate-terminated prepolymer for use in the first aspect is described below.

The isocyanate-terminated prepolymer used in the first aspect is prepared by reacting a polyol component with a polyisocyanate. The polyol component includes at least one low-molecular-weight polyol having a number average molecular weight of 400 to 1,000 and at least one high-molecular-weight polyol having a number average molecular weight of 3,000 to 12,000. According to the first aspect, an isocyanate-terminated prepolymer prepared by reacting two or more polyols having different molecular weights with a polyisocyanate may be used to inhibit the physical association of cells with the aid of the difference in reactivity between the isocyanate-terminated prepolymers derived from the low-molecular-weight polyol and the high-molecular-weight polyol. The first aspect can therefore provide a flexible polyurethane foam having a fine cell structure.

In the first aspect, the polyols used for the prepolymer may be a polyester polyol, a polyether polyol, or a mixture thereof.

Preferred examples of the polyether polyol used include those prepared by addition polymerization of an alkylene oxide with, for example, propylene glycol, ethylene glycol, glycerol, trimethylolpropane, or hexanetriol as a starting material. Particularly preferred are polyether polyols prepared by addition polymerization of ethylene oxide alone or in combination with propylene oxide with glycerol. Preferred examples of the polyester polyol used include condensed polyester polyols prepared by condensation of, for example, a dicarboxylic acid with a diol or a triol; lactone-based polyester polyols prepared by ring-opening polymerization of a lactone with a diol or a triol; and ester-modified polyols prepared by modifying the ends of a polyether polyol with a lactone.

The low-molecular-weight polyol has a number average molecular weight of 400 to 1,000, preferably 700 to 1,000, and preferably has a hydroxyl value of 150 to 500. The high-molecular-weight polyol has a number average molecular weight of 3,000 to 12,000, preferably 3,000 to 9,000, and preferably has a hydroxyl value of 15 to 60.

The proportion of the low-molecular-weight polyol in the polyol component used for the prepolymer is preferably 30% or more by weight, more preferably 40% to 50% by weight. If the proportion of the low-molecular-weight polyol in the polyol component is less than 30% by weight, the combined use of the low-molecular-weight polyol and the high-molecular-weight polyol cannot provide a sufficient effect. For an excessive proportion of the low-molecular-weight polyol in the polyol component, similarly, the combined use of the low-molecular-weight polyol and the high-molecular-weight polyol cannot provide a sufficient effect. In addition, an excessive proportion causes other problems such as high prepolymer viscosity which makes it difficult to homogeneously mix the prepolymer with, for example, a catalyst.

The polyisocyanate used for the prepolymer is preferably one or more materials selected from the group consisting of 2,4-tolylene diisocyanate (2,4-TDI), 2,6-tolylene diisocyanate (2,6-TDI), and diphenylmethane-4,4′-diisocyanate (MDI) (for example, a mixture of 2,4-TDI and 2,6-TDI).

The polyol component is preferably reacted with the polyisocyanate in a ratio of 1:0.15 to 1:0.5 (by weight). If the ratio of the polyisocyanate is more than the above range, the resultant prepolymer has a high free polyisocyanate content which speeds up the reaction between the polyisocyanate and a blowing agent. As a result, a foam with nonuniform cell size and shape is produced. If, on the other hand, the ratio of the polyisocyanate is less than the above range, the resultant prepolymer has high viscosity which decreases workability.

According to the first aspect, predetermined amounts of crosslinking agent and blowing component are added to the isocyanate-terminated prepolymer, which is prepared by reacting two or more polyols having different molecular weights with a polyisocyanate. The mixture is blown and cured by stirring.

The cross-linking agent used in the first aspect is preferably a low-molecular-weight polyol having a functionality of 2 or more, more preferably 3 or more. The addition of 3.0 to 10.0 parts by weight of the low-molecular-weight polyol based on 100 parts by weight of the isocyanate-terminated prepolymer provides higher cross-linking density so that even finer cells can be formed.

The low-molecular-weight polyol is exemplified by those having a molecular weight of 100 to 300, including trimethylolpropane, trimethylolpropanes modified with a polyoxyalkylene polyol (PO), and other polyalkylene polyols and polyether polyols.

The amount of cross-linking agent added is preferably controlled within the above range because an insufficient amount of cross-linking agent added fails to achieve sufficient cross-linking density while an excessive amount causes difficulty in providing a normal foam.

In combination with the above low-molecular-weight polyol, which preferably has a functionality of 2 or more, more preferably 3 or more, a diol such as ethylene glycol or propylene glycol may be used as another cross-linking agent unless it decreases the degree of cross-linking of the resultant flexible polyurethane foam.

The blowing component includes a blowing agent mainly containing water, a catalyst, and a foam stabilizer. The amount of blowing agent added is preferably 0.5 to 2.0 parts by weight based on 100 parts by weight of the isocyanate-terminated prepolymer.

The types and amounts of catalyst and foam stabilizer may be those employed typically in the production of flexible polyurethane foams. In addition to the above additive components, in the present invention, a flame retardant, an antioxidant, a colorant, an ultraviolet absorber, and other additives may be added unless they impair the performance of the fine cell flexible polyurethane foam according to the first aspect.

The fine cell flexible polyurethane foam thus produced according to the first aspect preferably has a fine cell structure with a density of 0.05 to 0.25 g/cm³ and an average cell size of 20 to 100 μm. Such a polyurethane foam delivers excellent performance in various applications.

The first aspect will be specifically described with the examples and comparative examples below.

The materials used in the examples and comparative examples below are as follows:
(1) Isocyanate Component
   Mixture of 80% 2,4-TDI and 20% 2,6-TDI: manufactured by Mitsui Takeda Chemicals, Inc.
(2) Polyol Component
   [Low-molecular-weight polyol]
      (a) Polyether polyol: the trade name “Actcall MN-400” (number average molecular weight: 400; hydroxyl value: 412), manufactured by Mitsui Takeda Chemicals, Inc.
      (b) Polyether polyol: the trade name “Actcall MN-700” (number average molecular weight: 700; hydroxyl value: 233), manufactured by Mitsui Takeda Chemicals, Inc.
      (c) Polypropylene polyol: the trade name “Actcall 32-160” (number average molecular weight: 1,000; hydroxyl value: 160), manufactured by Mitsui Takeda Chemicals, Inc.
   [High-molecular-weight polyol]
      (a) Polyether polyol: the trade name “SANNIX GS-3000” (number average molecular weight: 3,000; hydroxyl value: 56), manufactured by Sanyo Chemical Industries, Ltd.
      (b) Polyoxyalkylene polyol: the trade name “Actcall MF 78” (number average molecular weight: 4,800; hydroxyl value: 34), manufactured by Mitsui Takeda Chemicals, Inc.
      (c) Polyalkylene oxide polyol: the trade name “Actcall SHP-3900” (number average molecular weight: 9,000; hydroxyl value: 19.4), manufactured by Mitsui Takeda Chemicals, Inc.
(3) Cross-Linking Agent (low-molecular-weight polyol)
   Polyether polyol: the trade name “Actcall T-880” (number average molecular weight: 224; hydroxyl value: 880), manufactured by Mitsui Takeda Chemicals, Inc.
(4) Blowing Agent: water
(5) Catalyst
   Triethylenediamine (main component): the trade name “TOYOCAT TF,” manufactured by Tosoh Corporation
(6) Foam Stabilizer (silicone foam stabilizer)
   The trade name “SZ1127,” manufactured by Nippon Unicar Co., Ltd.

### EXAMPLE 1 AND COMPARATIVE EXAMPLE 1

The polyether polyol components were reacted with the polyisocyanate according to the compositions shown in Table 1 to prepare isocyanate-terminated prepolymers. The blowing component and the cross-linking agent were then added to the isocyanate-terminated prepolymers according to the compositions shown in Table 1. The mixtures were stirred to produce flexible polyurethane foams.

The densities and average cell sizes of the resultant flexible polyurethane foams were examined by the methods described below. The results are shown in Table 1.

[Density]

The weights of samples with dimensions of 50 mm by 300 mm by 300 mm were divided by the volumes thereof (according to JIS K 6401).

[Average Cell Size]

Test pieces were formed by horizontally cutting blocks in the growth direction. The cell size of each test piece was measured at 20 spots by observation with a stereoscopic microscope, and the measurements were averaged.

TABLE 1

| | | | | | | | | | Comparative |
|---|---|---|---|---|---|---|---|---|---|
| | | | | Example | | | | | Example |
| | | | | 1 | 2 | 3 | 4 | 5 | 1 |
| Composition | Isocyanate- | Low- | Polyether polyol (a) | 30 | | | | | |
| (parts by | terminated | molecular | Polyether polyol (b) | | 30 | | | | |
| weight) | prepolymer | -weight | Polypropylene polyol (c) | | | 38.5 | 38 | 38 | |
| | | polyol | | | | | | | |
| | | High- | Polyether polyol (a) | | | | 38 | 19 | |
| | | molecular | Polyoxyalkylene polyol | | 37 | 38.5 | | 19 | 82 |
| | | -weight | (b) | | | | | | |
| | | polyol | Polyalkylene oxide | 40 | | | | | |
| | | | polyol (c) | | | | | | |

| | | | | | | |
|---|---|---|---|---|---|---|
| Polyisocyanate | 30 | 33 | 23 | 24 | 24 | 18 |

| Isocyanate-terminated prepolymer | | 100 | 100 | 100 | 100 | 100 | 100 |
|---|---|---|---|---|---|---|---|
| subtotal | | | | | | | |
| Blowing | Blowing agent (water) | 0.8 | 1.6 | 0.6 | 0.8 | 1.0 | 1.5 |
| component | Amine-based catalyst | 1.0 | 1.0 | 1.0 | 1.0 | 1.0 | 1.0 |
| | Silicone-based foam | 1.5 | 1.5 | 1.5 | 1.5 | 1.5 | 1.5 |
| | stabilizer | | | | | | |

| | | | | | | | |
|---|---|---|---|---|---|---|---|
| | Cross-linking agent | 3.0 | 3.0 | 8.0 | 5.0 | 3.0 | — |
| Properties | Density (g/cm³) | 0.09 | 0.06 | 0.15 | 0.12 | 0.09 | 0.12 |
| | Average cell size (mm) | 60 | 90 | 40 | 30 | 70 | 250 |

Table 1 shows that the flexible polyurethane foams according to the first aspect had a significantly fine cell structure.

As described above, the first aspect provides a flexible polyurethane foam having a significantly fine cell structure.

The flexible polyurethane foam according to the first aspect, having the significantly fine cell structure, delivers remarkably excellent performance as a foam material for, for example, sound absorbers, electrodes, printer rollers, buffers, and cosmetic puffs.

A flame-retardant fine cell flexible polyurethane foam according to an embodiment of the second aspect will now be described in detail.

First, an isocyanate-terminated prepolymer for use in the second aspect is described below.

The isocyanate-terminated prepolymer used in the second aspect is prepared by reacting a polyol component with a polyisocyanate. The polyol component includes at least one low-molecular-weight polyol having a number average molecular weight of 400 to 1,000 and a functionality of 3 or more and at least one high-molecular-weight polyol having a number average molecular weight of 3,000 to 12,000 and a functionality of 3 or more. The weight ratio of the polyol component to the polyisocyanate is 1:0.15 to 1:0.4. Thus, an isocyanate-terminated prepolymer prepared by reacting two or more polyols having different molecular weights with a polyisocyanate at a predetermined ratio may be used to inhibit the physical association of cells with the aid of the difference in reactivity between the isocyanate-terminated prepolymers derived from the low-molecular-weight polyol and the high-molecular-weight polyol. The second aspect can therefore provide a flexible polyurethane foam having a fine cell structure.

In the second aspect, the polyols used for the prepolymer may be either a polyester polyol or a polyether polyol that has a functionality of 3 or more, or a mixture thereof.

Preferred examples of the polyether polyol used include those prepared by addition polymerization of an alkylene oxide with, for example, glycerol, trimethylolpropane, or hexanetriol as a starting material. Particularly preferred are polyether polyols prepared by addition polymerization of ethylene oxide alone or in combination with propylene oxide with glycerol. Preferred examples of the polyester polyol used include condensed polyester polyols prepared by condensation of, for example, a dicarboxylic acid with a triol; lactone-based polyester polyols prepared by ring-opening polymerization of a lactone with a triol; and ester-modified polyols prepared by modifying the ends of a polyether polyol with a lactone.

The low-molecular-weight polyol has a number average molecular weight of 400 to 1,000, preferably 700 to 1,000, and preferably has a hydroxyl value of 150 to 500. The high-molecular-weight polyol has a number average molecular weight of 3,000 to 12,000, preferably 3,000 to 9,000, and preferably has a hydroxyl value of 15 to 60.

The proportion of the low-molecular-weight polyol in the polyol component used for the prepolymer is 30% or more by weight, preferably 40% to 50% by weight. If the proportion of the low-molecular-weight polyol in the polyol component is less than 30% by weight, the combined use of the low-molecular-weight polyol and the high-molecular-weight polyol cannot provide a sufficient effect. For an excessive proportion of the low-molecular-weight polyol in the polyol component, similarly, the combined use of the low-molecular-weight polyol and the high-molecular-weight polyol cannot provide a sufficient effect. In addition, an excessive proportion causes other problems such as high prepolymer viscosity which makes it difficult to homogeneously mix the prepolymer with, for example, a catalyst.

The polyisocyanate used for the prepolymer is one or more materials selected from the group consisting of 2,4-tolylene diisocyanate (2,4-TDI), 2,6-tolylene diisocyanate (2,6-TDI), and diphenylmethane-4,4′-diisocyanate (MDI) (for example, a mixture of 2,4-TDI and 2,6-TDI).

The polyol component is reacted with the polyisocyanate in a ratio of 1:0.15 to 1:0.4 (by weight). If the ratio of the polyisocyanate is more than the above range, the resultant prepolymer has a high free polyisocyanate content which speeds up the reaction between the polyisocyanate and a blowing agent. As a result, a foam with nonuniform cell size and shape is produced. If, on the other hand, the ratio of the polyisocyanate is less than the above range, the resultant prepolymer has high viscosity which decreases workability.

According to the second aspect, predetermined amounts of flame retardant, crosslinking agent, foam stabilizer, and blowing component are added to the isocyanate-terminated prepolymer, which is prepared by reacting two or more trifunctional polyols having different molecular weights with a polyisocyanate. The mixture is blown and cured by stirring.

The flame retardant used is preferably a halogen-free phosphate-based flame retardant, specifically one or more materials selected from the group consisting of condensed phosphates, triethyl phosphate, and tributyl phosphate. In particular, a condensed phosphate is preferred.

The addition of 8.0 to 10.0 parts by weight of the flame retardant based on 100 parts by weight of the isocyanate-terminated prepolymer provides a flexible polyurethane foam with excellent flame retardancy. The amount of flame retardant added is preferably controlled within the above range because an insufficient amount of flame retardant added fails to achieve sufficient flame retardancy while an excessive amount causes difficulty in providing a normal foam.

The cross-linking agent used is a low-molecular-weight polyol having a functionality of 3 or more. The addition of 3.0 to 10.0 parts by weight of the low-molecular-weight polyol based on 100 parts by weight of the isocyanate-terminated prepolymer provides higher cross-linking density so that even finer cells can be formed.

The low-molecular-weight polyol is exemplified by those having a molecular weight of 100 to 300, including trimethylolpropane, trimethylolpropanes modified with a PO, and other polyalkylene polyols and polyether polyols.

The amount of cross-linking agent added is controlled within the above range because an insufficient amount of cross-linking agent added fails to achieve sufficient cross-linking density while an excessive amount causes difficulty in providing a normal foam.

In combination with the above low-molecular-weight polyol having a functionality of 3 or more, a diol such as ethylene glycol or propylene glycol may be used as another cross-linking agent unless it decreases the degree of cross-linking of the resultant flexible polyurethane foam.

The foam stabilizer used is preferably a flame-retardant foam stabilizer, more preferably a flame-retardant silicone-based foam stabilizer. A general foam stabilizer has a larger molecular weight than a flame-retardant foam stabilizer and, if a foam is burnt, the foam stabilizer keeps the foam burning because the burnt material hardly drips. Thus, a flame-retardant foam stabilizer having a low molecular weight is preferably used.

Even if such a flame-retardant foam stabilizer is used, an excessive amount of foam stabilizer added leads to a decrease in the flame retardancy of the flexible polyurethane foam. Accordingly, the amount of foam stabilizer added is preferably minimized as long as fine cells can be maintained; specifically, 0.6 to 1.0 part by weight is preferred based on 100 parts by weight of the isocyanate-terminated prepolymer. If the amount of foam stabilizer added is less than the above range, it cannot provide a sufficient effect of maintaining fine cells. If,. on the other hand, the amount of foam stabilizer added is more than the above range, a decrease in flame retardancy results.

The blowing component includes a blowing agent mainly containing water and a catalyst. The amount of blowing agent added is 0.5 to 2.0 parts by weight based on 100 parts by weight of the isocyanate-terminated prepolymer.

The type and amount of catalyst may be those employed typically in the production of flexible polyurethane foams. In addition to the above additive components, in the present invention, an antioxidant, a colorant, an ultraviolet absorber, and other additives may be added unless they impair the performance of the fine cell flexible polyurethane foam according to the second aspect.

The fine cell flexible polyurethane foam thus produced according to the second aspect preferably has a fine cell structure with a density of 0.05 to 0.25 g/cm³, an average cell size of 50 to 150 μm, and a flame retardancy of HBF or higher at a thickness of 10.0 mm or less according to UL 94 flammability testing. The flexible polyurethane foam therefore delivers excellent performance in applications requiring flame retardancy.

The second aspect will be specifically described with the examples and comparative examples below.

The materials used in the examples and comparative examples below are as follows:
(1) Isocyanate Component
   Mixture of 80% 2,4-TDI and 20% 2,6-TDI: manufactured by Mitsui Takeda Chemicals, Inc.
(2) Polyol Component
   [Low-molecular-weight polyol]
      (a) Polyether polyol: the trade name “Actcall MN-400” (number average molecular weight: 400; hydroxyl value: 412), manufactured by Mitsui Takeda Chemicals, Inc.
      (b) Polyether polyol: the trade name “Actcall MN-700” (number average molecular weight: 700; hydroxyl value: 233), manufactured by Mitsui Takeda Chemicals, Inc.
      (c) Polypropylene polyol: the trade name “Actcall 32-160” (number average molecular weight: 1,000; hydroxyl value: 160), manufactured by Mitsui Takeda Chemicals, Inc.
   [High-molecular-weight polyol]
      (a) Polyether polyol: the trade name “SANNIX GS-3000” (number average molecular weight: 3,000; hydroxyl value: 56), manufactured by Sanyo Chemical Industries, Ltd.
      (b) Polyoxyalkylene polyol: the trade name “Actcall MF-78” (number average molecular weight: 4,800;

hydroxyl value: 34), manufactured by Mitsui Takeda Chemicals, Inc.
(c) Polyalkylene oxide polyol: the trade name “Actcall SHP-3900” (number average molecular weight: 9,000; hydroxyl value: 19.4), manufactured by Mitsui Takeda Chemicals, Inc.
(3) Cross-Linking Agent (low-molecular-weight polyol)
   Polyether polyol: the trade name “Actcall T-880” (number average molecular weight: 224; hydroxyl value: 880), manufactured by Mitsui Takeda Chemicals, Inc.
(4) Flame retardant
   Condensed phosphate: the trade name “ADK STAB PFR,” manufactured by Asahi Denka Co., Ltd.
(5) Foam Stabilizer
   (a) Flame-retardant silicone-based foam stabilizer: the trade name “L5340,” manufactured by Nippon Unicar Co., Ltd.
   (b) Silicone-based foam stabilizer: the trade name “SZ1127,” manufactured by Nippon Unicar Co., Ltd.
(6) Blowing Agent: water
(7) Catalyst
   Triethylenediamine (main component): the trade name “TOYOCAT TF,” manufactured by Tosoh Corporation

### EXAMPLES 6 TO 10 AND COMPARATIVE EXAMPLES 2 TO 4

The polyether polyol components were reacted with the polyisocyanate according to the compositions shown in Table 2 to prepare isocyanate-terminated prepolymers. The blowing agent, the catalyst, the flame retardant, the foam stabilizers, and the cross-linking agent were then added to the isocyanate-terminated prepolymers according to the compositions shown in Table 2. The mixtures were stirred to produce flexible polyurethane foams.

The densities and average cell sizes of the resultant flexible polyurethane foams were examined by the methods described below, and were subjected to UL 94 flammability testing. The results are shown in Table 2.

[Density]

The weights of samples with dimensions of 50 mm by 300 mm by 300 mm were divided by the volumes thereof (according to JIS K 6401).

[Average cell size]

Test pieces were formed by horizontally cutting blocks in the growth direction. The cell size of each test piece was measured at 20 spots by observation with a stereoscopic microscope, and the measurements were averaged.

TABLE 2

| | | | | | | | | | Comparative | | |
|---|---|---|---|---|---|---|---|---|---|---|---|
| | | | | Example | | | | | Example | | |
| | | | | 6 | 7 | 8 | 9 | 10 | 2 | 3 | 4 |
| Composition | Isocyanate-terminated | Low- | Polyether | 30 | | | | | | | |
| (parts by | prepolymer | molecular- | polyol (a) | | | | | | | | |
| weight) | | weight | Polyether | | 30 | | | | | | |
| | | polyol | polyol (b) | | | | | | | | |
| | | | Polypropylene | | | 38.5 | 38 | 38 | | 38.5 | 38.5 |
| | | | polyol (c) | | | | | | | | |
| | | High- | Polyether | | | | 38 | 19 | | | |
| | | molecular- | polyol (a) | | | | | | | | |
| | | weight | Polyoxy- | | 37 | 38.5 | | 19 | 82 | 38.5 | 38.5 |
| | | polyol | alkylene | | | | | | | | |
| | | | polyol (b) | | | | | | | | |
| | | | Polyalkylene | 40 | | | | | | | |
| | | | oxide | | | | | | | | |
| | | | polyol (c) | | | | | | | | |

| | | | | | | | | |
|---|---|---|---|---|---|---|---|---|
| Polyisocyanate | 30 | 33 | 23 | 24 | 24 | 18 | 23 | 23 |

| Isocyanate-terminated | | 100 | 100 | 100 | 100 | 100 | 100 | 100 | 100 |
|---|---|---|---|---|---|---|---|---|---|
| prepolymer subtotal | | | | | | | | | |
| Blowing | Blowing | 0.8 | 1.6 | 0.6 | 0.8 | 1.0 | 1.5 | 0.6 | 0.6 |
| component | agent | | | | | | | | |
| | (water) | | | | | | | | |
| | Amine- | 1.0 | 1.0 | 1.0 | 1.0 | 1.0 | 1.0 | 1.0 | 1.0 |
| | based | | | | | | | | |
| | catalyst | | | | | | | | |

| | | | | | | | | | |
|---|---|---|---|---|---|---|---|---|---|
| | Flame-retardant | 0.6 | 1.0 | 0.8 | 0.8 | 0.8 | — | — | 0.8 |
| | silicone-based | | | | | | | | |
| | foam stabilizer | | | | | | | | |
| | Silicone-based | — | — | — | — | — | 2.5 | 0.8 | — |
| | foam stabilizer | | | | | | | | |
| | Flame retardant | 10 | 10 | 8.0 | 10 | 10 | — | 8.0 | — |
| | Cross-linking agent | 3.0 | 3.0 | 5.0 | 5.0 | 3.0 | — | 5.0 | 5.0 |
| Properties | Density (g/cm³) | 0.09 | 0.06 | 0.15 | 0.12 | 0.09 | 0.12 | 0.15 | 0.14 |
| | Average cell size (mm) | 100 | 150 | 100 | 80 | 120 | 250 | 100 | 100 |
| | Flame retardancy | HBF | HBF | HBF | HBF | HBF | NG | NG | NG |
| | (thickness: 10.0 | or | or | or | or | or | | | |
| | mm or less) | higher | higher | higher | higher | higher | | | |

Table 2 shows that the flexible polyurethane foams according to the second aspect had a significantly fine cell structure with excellent flame retardancy.

As described above, the second aspect provides a flame-retardant flexible polyurethane foam having a significantly fine cell structure.

The flame-retardant flexible polyurethane foam according to the second aspect, having the significantly fine cell structure and the excellent flame retardancy, delivers remarkably excellent performance as a foam material for, for example, sound absorbers for OA equipment and vehicles, electrodes, printer rollers, toner seals, air seals, and buffers for use in various fields requiring flame retardancy.

1. A fine cell flexible polyurethane foam produced by blowing and curing a mixture of an isocyanate-terminated prepolymer, a cross-linking agent, and a blowing component,
the isocyanate-terminated prepolymer being prepared by reacting a polyol component with a polyisocyanate, the polyol component including at least one low-molecular-weight polyol having a number average molecular weight of 400 to 1,000 and at least one high-molecular-weight polyol having a number average molecular weight of 3,000 to 12,000.

2. The fine cell flexible polyurethane foam according to claim 1, wherein the proportion of the low-molecular-weight polyol in the polyol component is 30% or more by weight.

3. The fine cell flexible polyurethane foam according to claim 2, wherein the proportion of the low-molecular-weight polyol in the polyol component is 30% to 50% by weight.

4. The fine cell flexible polyurethane foam according to claim 1, wherein the isocyanate-terminated prepolymer is prepared by reacting the polyol component with the polyisocyanate in a weight ratio of 1:0.15 to 1:0.5.

5. The fine cell flexible polyurethane foam according to claim 1, wherein the cross-linking agent is a low-molecular-weight polyol having a functionality of 2 or more, and the amount of the cross-linking agent added is 3.0 to 10.0 parts by weight based on 100 parts by weight of the isocyanate-terminated prepolymer.

6. The fine cell flexible polyurethane foam according to claim 1, wherein the blowing component includes a blowing agent mainly containing water, a catalyst, and a foam stabilizer, and the amount of the blowing agent added is 0.5 to 2.0 parts by weight based on 100 parts by weight of the isocyanate-terminated prepolymer.

7. The fine cell flexible polyurethane foam according to claim 1, wherein the polyisocyanate is one or more materials selected from the group consisting of 2,4-tolylene diisocyanate, 2,6-tolylene diisocyanate, and diphenylmethane-4,4′-diisocyanate.

8. The fine cell flexible polyurethane foam according to claim 1, having a density of 0.05 to 0.25 g/cm³ and an average cell size of 20 to 100 μm.

9. A flame-retardant fine cell flexible polyurethane foam produced by blowing and curing a mixture of an isocyanate-terminated prepolymer, a flame retardant, a cross-linking agent, a foam stabilizer, and a blowing component,
the isocyanate-terminated prepolymer being prepared by reacting a polyol component with a polyisocyanate at a weight ratio of 1:0.15 to 1:0.4, the polyol component including at least one low-molecular-weight polyol having a number average molecular weight of 400 to 1,000 and a functionality of 3 or more and at least one high-molecular-weight polyol having a number average molecular weight of 3,000 to 12,000 and a functionality of 3 or more, the proportion of the low-molecular-weight polyol in the polyol component being 30% or more by weight, wherein
the cross-linking agent is a low-molecular-weight polyol having a functionality of 3 or more, and the amount of the cross-linking agent added is 3.0 to 10.0 parts by weight based on 100 parts by weight of the isocyanate-terminated prepolymer;
the blowing component includes a blowing agent mainly containing water and a catalyst, and the amount of the blowing agent added is 0.5 to 2.0 parts by weight based on 100 parts by weight of the isocyanate-terminated prepolymer; and
the polyisocyanate is one or more materials selected from the group consisting of 2,4-tolylene diisocyanate, 2,6-tolylene diisocyanate, and diphenylmethane-4, 4′-diisocyanate.

10. The flame-retardant fine cell flexible polyurethane foam according to claim 9, wherein the flame retardant is a halogen-free phosphate-based flame retardant.

11. The flame-retardant fine cell flexible polyurethane foam according to claim 9, wherein the amount of the flame retardant added is 8.0 to 10.0 parts by weight based on 100 parts by weight of the isocyanate-terminated prepolymer.

12. The flame-retardant fine cell flexible polyurethane foam according to claim 9, wherein the foam stabilizer is a flame-retardant silicone-based foam stabilizer.

13. The flame-retardant fine cell flexible polyurethane foam according to claim 9, wherein the amount of the foam stabilizer added is 0.6 to 1.0 part by weight based on 100 parts by weight of the isocyanate-terminated prepolymer.

14. The flame-retardant fine cell flexible polyurethane foam according to claim 9, wherein the proportion of the low-molecular-weight polyol in the polyol component is 30% to 50% by weight.

15. The flame-retardant fine cell flexible polyurethane foam according to claim 9, having a density of 0.05 to 0.25 g/cm³, an average cell size of 50 to 150 μm, and a flame retardancy of HBF or higher at a thickness of 10.0 mm or less according to UL 94 flammability testing.
